(19) United States
(12) Patent Application Publication
(10) Pub. No.: US 2026/0292878 A1
(43) Pub. Date: Sep. 24, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/167,360

(22) PCT Filed: Mar. 20, 2023
(86) PCT No.: PCT/CN2023/082599

§ 371 Date: Sep. 19, 2025

(51) Int. Cl. H04W 74/0816; H04W 52/02

(52) U.S. Cl. CPC H04W 74/0816; H04W 52/0206

(57) ABSTRACT

A communication method includes determining a first frame, where the first frame includes a first information, the first information indicates sleeping period information of the first AP, and the first information indicates that a second AP is allowed to communicate with a station device during a sleeping period of the first AP. The method further includes sending the first frame.

### CROSS-REFERENCE TO RELATED APPLICATION

The present application is a U.S. National Stage of International Application No. PCT/CN2023/082599, filed on Mar. 20, 2023, the entire content of which is incorporated herein by reference for all purposes.

### TECHNICAL FIELD

Embodiments of the present disclosure relate to the field of mobile communication technology, and more specifically, the embodiments of the present disclosure relate to a communication method, an electronic device, and a storage medium.

### BACKGROUND

With the rapid development of mobile communication technology, wireless fidelity (Wi-Fi) technology has made tremendous progress in terms of transmission rate and throughput, etc. Currently, contents studied in the Wi-Fi technology, such as ultra high reliability (UHR), have a vision of improving reliability of wireless local area network (WLAN) links, reducing latency, improving manageability, increasing throughput at different signal-to-noise ratio (SNR) levels, and lowering device level power consumption, etc. Furthermore, in UHR, in order to improve the system throughput, a method of a simultaneous communication in the sub 7 GHz (gigahertz) and 45 GHz and/or 60 GHz frequency bands has been proposed.

In UHR, it is required to further coordinate a collaboration mode between a plurality of access point (AP) devices for further enhancement to meet a transmission requirement of the UHR.

### SUMMARY

The embodiments of the present disclosure provide a communication method, an electronic device, and a storage medium.

In an aspect, the embodiments of the present disclosure provide a communication method applied to a first AP, and the method includes: determining a first frame, where the first frame includes a first information element, the first information element indicates sleeping period information of the first AP, and the first information element indicates that a second AP is allowed to communicate with a station device during a sleeping period of the first AP; and sending the first frame.

In another aspect, the embodiments of the present disclosure provide a communication method applied to a second AP, and the method includes: receiving a first frame, where the first frame includes a first information element, the first information element indicates sleeping period information of the first AP, and the first information element indicates that a second AP is allowed to communicate with a station device during a sleeping period of the first AP.

In another aspect, the embodiments of the present disclosure provide a communication method applied to a station device (STA), and the method includes: receiving a first frame, where the first frame includes a first information element, the first information element indicates sleeping period information of a first AP, and the first information element indicates that a second AP is allowed to communicate with the STA during a sleeping period of the first AP; the second AP is an AP belonging to a same overlapping basic service set (OBSS) as the first AP.

The embodiments of the present disclosure also provide an electronic device including a memory, a processor, and a computer program stored in the memory and executable on the processor, where the processor, when executing the program, implements the method according to one or more of the embodiments of the present disclosure.

The embodiments of the present disclosure also provide a computer-readable storage medium. The computer-readable storage medium stores a computer program, where the computer program, when executed by a processor, implements the method according to one or more of the embodiments of the present disclosure.

Additional aspects and advantages of the embodiments of the present disclosure will be partially provided in the following description, and these will become apparent from the following description or will be learned through practice of the present disclosure.

### BRIEF DESCRIPTION OF THE DRAWINGS

To more clearly illustrate the technical solutions of the embodiments of the present disclosure, the following will provide a brief introduction to the accompanying drawings to be used in the description of the embodiments of the present disclosure. It is apparent that the accompanying drawings described below are merely some embodiments of the present disclosure. For those of ordinary skill in the art, other accompanying drawings can be obtained based on these accompanying drawings without creative labor.

FIG. 1 is a first flowchart of a communication method provided in an embodiment of the present disclosure.

FIG. 2 is a schematic diagram of a first example of an embodiment of the present disclosure.

FIG. 3 is a second flowchart of a communication method provided in an embodiment of the present disclosure.

FIG. 4 is a schematic diagram of a second example of an embodiment of the present disclosure.

FIG. 5 is a third flowchart of a communication method provided in an embodiment of the present disclosure.

FIG. 6 is a schematic diagram of a third example of an embodiment of the present disclosure.

FIG. 7 is a first schematic structural diagram of an electronic device provided in an embodiment of the present disclosure.

FIG. 8 is a second schematic structural diagram of an electronic device provided in an embodiment of the present disclosure.

FIG. 9 is a third schematic structural diagram of an electronic device provided in an embodiment of the present disclosure.

FIG. 10 is a fourth schematic structural diagram of an electronic device provided in an embodiment of the present disclosure.

### DETAILED DESCRIPTION

The exemplary embodiments are described in detail herein, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the present invention. On the contrary, they are only examples of devices and methods consistent with some aspects of the present invention as detailed in the appended claims.

In the embodiments of the present disclosure, the terms as used are solely for the purpose of describing particular embodiments, but are not intended to limit the present disclosure. The singular forms of “a”, “the”, and “said” used in the present disclosure and the appended claims are also intended to include the plural form, unless the context clearly indicates other meanings. It should also be understood that the term “and/or” as used in this article refers to and includes any or all possible combinations of one or more of the associated listed items. For example, A and/or B may indicate three cases: A exists alone, A and B exist simultaneously, and B exists alone. The character “/” generally indicates an “or” relationship between the preceding and following associated items. The term “a plurality of” refers to two or more. Accordingly, “a plurality of” in the embodiments of the present disclosure may also be understood as “at least two”.

It should be understood that although the terms first, second, third, etc. may be used in the present disclosure to describe various types of information, such information should not be limited to these terms. These terms are only used to distinguish the same type of information from one another. For example, without departing from the scope of the present disclosure, the first information may also be referred to as the second information, and similarly, the second information may also be referred to as the first information. Depending on the context, for example, the phrase “if” as used herein may be interpreted as “at the time of . . . ” , “when . . . ” , or “in response to determining”.

The following will provide a clear and complete description of the technical solutions in the embodiments of the present disclosure based on the accompanying drawings in the embodiments of the present disclosure. It is apparent that the described embodiments are only a part of the embodiments of the present disclosure and not all of them. Based on the embodiments of the present disclosure, all other embodiments obtained by those ordinary skilled in the art without creative labor are within the scope of protection of the present disclosure.

The embodiments of the present disclosure provide a communication method, an electronic device, and a storage medium for further enhancing the collaboration mode between a plurality of APs.

The method and device are based on the same application concept. Due to the similarity in the principle for solving problems between the method and the device, the implementations of the device and the implementations of the method can be referred to each other, and the repetition will not be repeated.

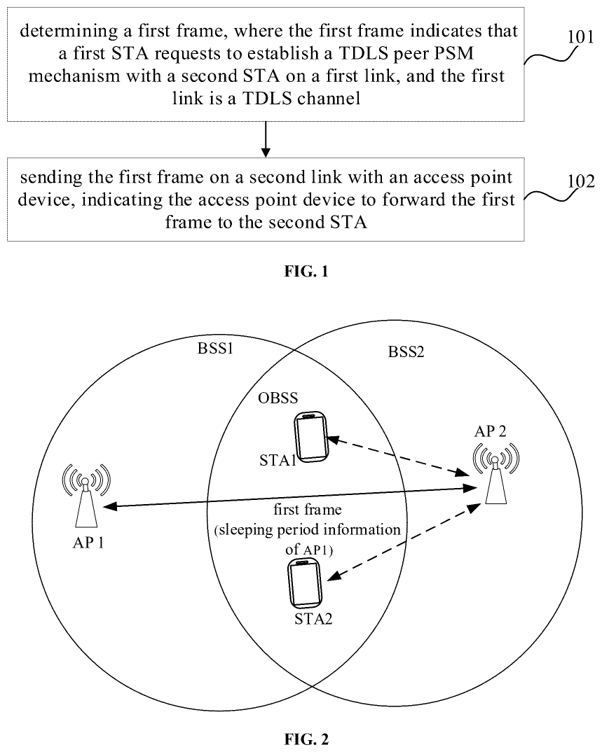

As shown in FIG. 1, an embodiment of the present disclosure provides a communication method. In an example, the method may be applied to a first AP device. In an example, in an embodiment of the present disclosure, for example, an AP may be a device with a wireless-to-wired bridging function. The AP is responsible for extending services provided by a wired network to a wireless network. For example, an STA may be an electronic device with a wireless network access function, providing frame delivery services to enable information transmission.

The method may include the following steps 101 to 102.

At step 101, a first frame is determined, where the first frame includes a first information element, the first information element indicates sleeping period information of the first AP, and the first information element indicates that a second AP is allowed to communicate with a station device during a sleeping period of the first AP.

At step 102, the first frame is sent.

In an example, the first AP and the second AP may be APs in a same overlapping basic service set (OBSS). Specifically, in a WLAN, a basic service set (BSS) may include an AP and one or more stations (STAs) communicating with the AP. When the coverage ranges of two or more BSSs are overlapped with each other, an OBSS is formed. With the rapid increase in wireless devices and applications, an increasing number of WLANs are deployed in a dense environment composed of a plurality of OBSSs, and there are often wireless communication devices with different protocol standards in the limited environment. High-density WLAN deployment inevitably leads to overlapping regions between adjacent BSSs. To avoid interference, APs in adjacent BSSs must operate in different frequency bands. However, due to limited available frequency band resources, this requirement is often not met. When a plurality of unrelated BSSs operating in the same frequency band or with partially overlapping frequency bands are close enough to receive each other's transmission information, the AP or the STA in the BSS that is transmitting information will block the AP or the STA in other BSSs from transmitting information, which forms the problem of co-channel interference in OBSS networks, severely impacting network performance and potentially causing network paralysis.

In the embodiments of the present disclosure, the first AP determines the first frame, where the first frame includes the first information element, the first information element indicates the sleeping (or power saving) period information of the first AP, and the sleeping period information of the first AP may identify the first AP's sleeping start time, sleeping end time, periodic sleeping period information, or time information in the power saving state, etc. The first information element indicates that a second AP is allowed to communicate with a station device during the sleeping period of the first AP. The sleeping (or power saving state) time of the first AP is shared through the first information element, and the second AP is indicated through the first information element to be capable of communicating with a station device during the sleeping period of the first AP, where the second AP is an AP in a same OBSS as the first AP, and there may be one or more second APs. In this way, the OBSS interference between the second AP and the first AP can be avoided, the communication time between the second AP and the station device can be increased, and the service transmission efficiency can be enhanced.

In an example, the first frame includes a beacon frame; or the first frame may include a new frame, such as an AP PS announcement frame for broadcasting the sleeping period information of the first AP.

It can be understood that in the embodiments of the present disclosure, the AP and the STA may be devices supporting multi-link. For example, the AP and the STA may be represented as AP (multi-link device) MLD and non-AP MLD, respectively. The AP MLD may represent an access point supporting a multi-link communication function. The non-AP MLD may represent a station supporting a multi-link communication function. For ease of explanation, subsequent descriptions use the AP and the STA as examples; however, this does not constitute a limitation on the embodiments of the present disclosure.

As a first example, referring to FIG. 2, which shows one application scenario of a communication method provided in an embodiment of the present disclosure. The AP1 and the STA1 form the BSS1. The AP2 and the STA2 form the BSS2. The BSS1 and the BSS2 overlap with each other to form an OBSS. Taking the AP1 as the first AP as an example, the AP1 determines a first frame, carries the sleeping period information of the AP1 in the first frame, and broadcasts the first frame. Consequently, the AP2 can communicate with the STA in the OBSS during the sleeping period of the AP1, and OBSS interference between the AP2 and the AP1 can be avoided.

The embodiments of the present disclosure provide a communication method applied to a first AP. The method includes: determining a first frame, where the first frame includes a first information element, the first information element indicates sleeping period information of the first AP, and the first information element indicates that a second AP is allowed to communicate with a station device during a sleeping period of the first AP; and sending the first frame.

In some embodiments, the first frame is sent by the first AP on a first link.

The first information element further indicates sleeping period information of a third AP on a second link. The third AP is an AP belonging to a same AP MLD as the first AP. If the first AP is affiliated with a certain AP MLD and another AP (e.g., the third AP) on another link has also negotiated its sleeping period, the first AP may also broadcast, on the first link, the sleeping period of the AP on the another link. For example, the third AP operates on the second link, then the first AP may broadcast, on the first link, the sleeping period information of the third AP, indicating that other APs are capable of communicating with the station device during the sleeping period of the third AP.

The embodiments of the present disclosure provide a communication method applied to a first AP. The method includes: determining a first frame, where the first frame includes a first information element, the first information element indicates sleeping period information of the first AP, and the first information element indicates that a second AP is allowed to communicate with a station device during a sleeping period of the first AP; and sending the first frame on a first link.

In some embodiments, the first information element further indicates sleeping period information of a third AP on a second link. The third AP is an AP belonging to a same AP MLD as the first AP.

The sleeping period information of the third AP includes time offset information used for calculating a specific time point of the sleeping period information of the third AP. The time offset information includes a time offset value between a start time of a sleeping period of the third AP on the second link and a start time of the sleeping period of the first AP on the first link. That is, the time offset information is the time difference between the start times of the sleeping period information of the two APs. In this way, the specific time point of the sleeping period information of the third AP can be calculated by using the start time of the sleeping period of the broadcast link (i.e., the first link) and the time offset value.

The embodiments of the present disclosure provide a communication method applied to a first AP. The method includes: determining a first frame, where the first frame includes a first information element, the first information element indicates sleeping period information of the first AP, and the first information element indicates that a second AP is allowed to communicate with a station device during a sleeping period of the first AP; and sending the first frame.

In some embodiments, the first frame is sent by the first AP on a first link.

The first information element further indicates sleeping period information of a third AP on a second link. A sleeping period of the third AP on the second link is the same as a quiet period in quiet element information of the third AP. To ensure subsequent compatibility, the time of the sleeping period of the third AP needs to be consistent with the time set in the quiet element of the third AP. A legacy STA cannot communicate with the third AP during the quiet time set in the quiet element, and consequently cannot send any frame to communicate with the third AP during the time duration in the sleeping period.

The embodiments of the present disclosure provide a communication method applied to a first AP. The method includes: determining a first frame, where the first frame includes a first information element, the first information element indicates sleeping period information of the first AP, and the first information element indicates that a second AP is allowed to communicate with a station device during a sleeping period of the first AP; and sending the first frame.

In some embodiments, the first frame is sent by the first AP on a first link.

The first information element further indicates sleeping period information of a third AP on a second link.

The third AP is an AP belonging to a same AP MLD as the first AP.

The sleeping period of the first AP on the first link is the same as a quiet period in quiet element information of the first AP. To ensure subsequent compatibility, the time of the sleeping period of the first AP needs to be consistent with the time set in the quiet element of the first AP. A legacy STA cannot communicate with the first AP during the quiet time set in the quiet element, and consequently cannot send any frame to communicate with the first AP during the time duration in the sleeping period.

The embodiments of the present disclosure provide a communication method applied to a first AP. The method includes: determining a first frame, where the first frame includes a first information element, the first information element indicates sleeping period information of the first AP, and the first information element indicates that a second AP is allowed to communicate with a station device during a sleeping period of the first AP; and sending the first frame on a first link, where the first frame includes quiet element information of the first AP, and the first AP broadcasts its quiet element on the first link.

In some embodiments, the sleeping period of the first AP on the first link is the same as a quiet period in the quiet element information of the first AP to ensure subsequent compatibility.

The embodiments of the present disclosure provide a communication method applied to a first AP. The method includes: determining a first frame, where the first frame includes a first information element, the first information element indicates sleeping period information of the first AP, and the first information element indicates that a second AP is allowed to communicate with a station device during a sleeping period of the first AP; and sending the first frame.

In an example, the first frame is sent by the first AP on a first link.

The first information element further indicates sleeping period information of a third AP on a second link.

The third AP is an AP belonging to a same AP MLD as the first AP.

In an example, the sleeping period information of the third AP includes time offset information.

The time offset information includes a time offset value between a start time of a sleeping period of the third AP on the second link and a start time of the sleeping period of the first AP on the first link.

In an example, a sleeping period of the third AP on the second link is the same as a quiet period in the quiet element information of the third AP.

In an example, the sleeping period of the first AP on the first link is the same as a quiet period in the quiet element information of the first AP.

In an example, the first frame includes the quiet element information of the first AP.

In an example, the first frame includes a beacon frame.

In the embodiments of the present disclosure, the first AP determines the first frame, where the first frame includes the first information element, the first information element indicates the sleeping period information of the first AP, and the first information element indicates that a second AP is allowed to communicate with a station device during the sleeping period of the first AP. The sleeping time of the first AP is shared through the first information element, and the second AP is indicated through the first information element to be capable of communicating with a station device during the sleeping period of the first AP. This can avoid the OBSS interference between the second AP and the first AP, increase the communication time between the second AP and the station device, and enhance the service transmission efficiency.

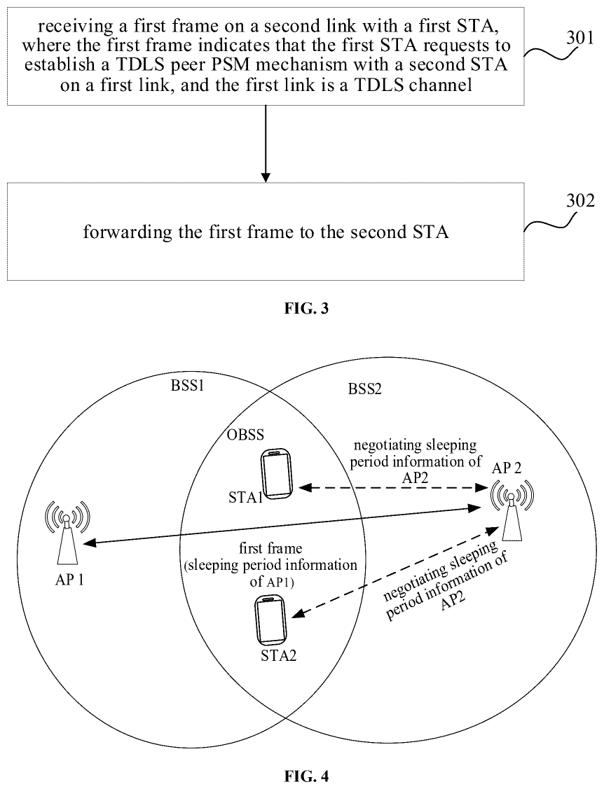

Referring to FIG. 3, the embodiments of the present disclosure provide a communication method. In an example, the method may be applied to a second AP. The method may include the following step 301.

At step 301, a first frame is received, where the first frame includes a first information element, the first information element indicates sleeping period information of the first AP, and the first information element indicates that a second AP is allowed to communicate with a station device during a sleeping period of the first AP.

In an example, the second AP is an AP belonging to a same OBSS as the first AP. Specifically, in a WLAN, a BSS may include an AP and one or more stations communicating with the AP. When the coverage ranges of two or more BSSs are overlapped with each other, an OBSS is formed. With the rapid increase in wireless devices and applications, an increasing number of WLANs are deployed in a dense environment composed of a plurality of OBSSs, and there are often wireless communication devices with different protocol standards in the limited environment. High-density WLAN deployment inevitably leads to overlapping regions between adjacent BSSs. To avoid interference, APs in adjacent BSSs must operate in different frequency bands. However, due to limited available frequency band resources, this requirement is often not met. When a plurality of unrelated BSSs operating in the same frequency band or with partially overlapping frequency bands are close enough to receive each other's transmission information, the AP or the STA in the BSS that is transmitting information will block the AP or the STA in other BSSs from transmitting information, which forms the problem of co-channel interference in OBSS networks, severely impacting network performance and potentially causing network paralysis.

In the embodiments of the present disclosure, the second AP receives the first frame, and obtains the first information element in the first frame, where the first information element indicates the sleeping (or power saving) period information of the first AP, and the sleeping period information of the first AP may identify the first AP's sleeping start time, sleeping end time, periodic sleeping period information, or time information in the power saving state, etc. The first information element indicates that a second AP is allowed to communicate with a station device during the sleeping period of the first AP. The sleeping (or power saving state) time of the first AP is shared through the first information element, and the second AP is indicated through the first information element to be capable of communicating with a station device during the sleeping period of the first AP, where the second AP is an AP in a same OBSS as the first AP, and there may be one or more second APs. In this way, the OBSS interference between the second AP and the first AP can be avoided, the communication time between the second AP and the station device can be increased, and the service transmission efficiency can be enhanced.

In an example, the first frame includes a beacon frame, or the first frame includes a new frame, such as an AP PS announcement frame for broadcasting the sleeping period information of the first AP.

It can be understood that in the embodiments of the present disclosure, the AP and the STA may be devices supporting multi-link. For example, the AP and the STA may be represented as AP MLD and non-AP MLD, respectively. The AP MLD may represent an access point supporting a multi-link communication function. The non-AP MLD may represent a station supporting a multi-link communication function. For ease of explanation, subsequent descriptions use the AP and the STA as examples; however, this does not constitute a limitation on the embodiments of the present disclosure.

As a first example, referring to FIG. 2, which shows one application scenario of a communication method provided in an embodiment of the present disclosure. The AP1 and the STA1 form the BSS1. The AP2 and the STA2 form the BSS2. The BSS1 and the BSS2 are overlapped with each other to form an OBSS. Taking the AP1 as the first AP as an example, the AP1 determines a first frame, carries the sleeping period information of the AP1 in the first frame, and broadcasts the first frame. Consequently, the AP2 can communicate with the STA in the OBSS during the sleeping period of the AP1, and OBSS interference between the AP2 and the AP1 can be avoided.

The embodiments of the present disclosure provide a communication method. In an example, the method may be applied to a second AP. The method may include the following steps: receiving a first frame, where the first frame includes a first information element, the first information element indicates sleeping period information of the first AP, and the first information element indicates that a second AP is allowed to communicate with a station device during a sleeping period of the first AP; and determining sleeping period information of the second AP based on the sleeping period information of the first AP, where a sleeping period of the second AP is not overlapped with the sleeping period of the first AP.

In some embodiments, the second AP serves as a listening AP. Based on the received sleeping period of the first AP, the second AP negotiates the sleeping period of the second AP with the STA. The negotiated sleeping period is not overlapped in time with the sleeping period of the first AP, which increases the communication time between the second AP and the station device, and enhances service transmission efficiency. As a second example, referring to FIG. 4, which shows a second application scenario of a communication method provided in an embodiment of the present disclosure. The AP1 and the STA1 form the BSS1. The AP2 and the STA2 form the BSS2. The BSS1 and the BSS2 are overlapped with each other to form an OBSS. Taking the AP1 as the first AP as an example, the AP1 carries the sleeping period information of the AP1 in the first frame, and broadcasts the first frame.

Consequently, based on the received sleeping period of the first AP, the AP2 negotiates the sleeping period of the AP2 with the STA1/STA2 in the OBSS. The negotiated sleeping period is not overlapped in time with the sleeping period of the first AP. In this way, the AP2 can communicate with the STA1/STA2 during the sleeping period of the AP1 subsequently.

The embodiments of the present disclosure provide a communication method. In an example, the method may be applied to a second AP. The method may include the following steps: receiving a first frame, where the first frame includes a first information element, the first information element indicates sleeping period information of the first AP, and the first information element indicates that a second AP is allowed to communicate with a station device during a sleeping period of the first AP; and determining sleeping period information of the second AP based on the sleeping period information of the first AP, where a sleeping period of the second AP is not overlapped with the sleeping period of the first AP.

The first frame is sent by the first AP on a first link.

In some embodiments, the first information element further indicates sleeping period information of a third AP on a second link. The third AP is an AP belonging to a same AP MLD as the first AP. A sleeping period of the second AP is not overlapped with a sleeping period of the third AP.

If the first AP is affiliated with a certain AP MLD and another AP (e.g., the third AP) on another link has also negotiated its sleeping period, the first AP may also broadcast, on the first link, the sleeping period of the AP on the another link. For example, the third AP operates on the second link, then the first AP may broadcast, on the first link, the sleeping period information of the third AP, indicating that other APs are capable of communicating with the station device during the sleeping period of the third AP.

The second AP serves as a listening AP. Based on the received sleeping period of the third AP, the second AP negotiates the sleeping period of the second AP with the STA. The negotiated sleeping period is not overlapped in time with the sleeping period of the third AP, which increases the communication time between the second AP and the station device, and enhances service transmission efficiency.

The embodiments of the present disclosure provide a communication method. In an example, the method may be applied to a second AP. The method may include the following steps: receiving a first frame, where the first frame includes a first information element, the first information element indicates sleeping period information of the first AP, and the first information element indicates that a second AP is allowed to communicate with a station device during a sleeping period of the first AP; and determining sleeping period information of the second AP based on the sleeping period information of the first AP, where a sleeping period of the second AP is not overlapped with the sleeping period of the first AP.

The first frame is sent by the first AP on a first link.

The first information element further indicates sleeping period information of a third AP on a second link. The third AP is an AP belonging to a same AP MLD as the first AP. The sleeping period of the second AP is not overlapped with a sleeping period of the third AP.

The sleeping period information of the third AP includes time offset information used for calculating a specific time point of the sleeping period information of the third AP. The time offset information includes a time offset value between a start time of the sleeping period of the third AP on the second link and a start time of the sleeping period of the first AP on the first link. That is, the time offset information is the time difference between the start times of the sleeping period information of the two APs. In this way, the specific time point of the sleeping period information of the third AP can be calculated by using the start time of the sleeping period of the broadcast link (i.e., the first link) and the time offset value.

The embodiments of the present disclosure provide a communication method. In an example, the method may be applied to a second AP. The method may include the following steps: receiving a first frame, where the first frame includes a first information element, the first information element indicates sleeping period information of the first AP, and the first information element indicates that a second AP is allowed to communicate with a station device during a sleeping period of the first AP; and determining sleeping period information of the second AP based on the sleeping period information of the first AP, where a sleeping period of the second AP is not overlapped with the sleeping period of the first AP.

The first frame is sent by the first AP on a first link.

The first information element further indicates sleeping period information of a third AP on a second link. The third AP is an AP belonging to a same AP MLD as the first AP.

The sleeping period of the second AP is not overlapped with a sleeping period of the third AP. The sleeping period information of the third AP includes time offset information. The time offset information includes a time offset value between a start time of the sleeping period of the third AP on the second link and a start time of the sleeping period of the first AP on the first link.

The sleeping period of the third AP on the second link is the same as a quiet period in quiet element information of the third AP. To ensure subsequent compatibility, the time of the sleeping period of the third AP needs to be consistent with the time set in the quiet element of the third AP. A legacy STA cannot communicate with the third AP during the quiet time set in the quiet element, and consequently cannot send any frame to communicate with the third AP during the time duration in the sleeping period.

The embodiments of the present disclosure provide a communication method. In an example, the method may be applied to a second AP. The method may include the following step: receiving a first frame, where the first frame includes a first information element, the first information element indicates sleeping period information of the first AP, and the first information element indicates that a second AP is allowed to communicate with a station device during a sleeping period of the first AP.

In some embodiments, the sleeping period of the second AP is the same as a quiet period in quiet element information of the second AP. To ensure subsequent compatibility, the time of the sleeping period of the second AP needs to be consistent with the time set in the quiet element of the second AP. A legacy STA cannot communicate with the second AP during the quiet time set in the quiet element, and consequently cannot send any frame to communicate with the second AP during the time duration in the sleeping period.

The embodiments of the present disclosure provide a communication method. In an example, the method may be applied to a second AP. The method may include the following steps: receiving a first frame, where the first frame includes a first information element, the first information element indicates sleeping period information of the first AP, and the first information element indicates that a second AP is allowed to communicate with a station device during a sleeping period of the first AP; and determining sleeping period information of the second AP based on the sleeping period information of the first AP, where a sleeping period of the second AP is not overlapped with the sleeping period of the first AP.

In some embodiments, the first frame is sent by the first AP on a first link. The sleeping period of the first AP on the first link is the same as a quiet period in quiet element information of the first AP.

The embodiments of the present disclosure provide a communication method. In an example, the method may be applied to a second AP. The method may include the following steps: receiving a first frame, where the first frame includes a first information element, the first information element indicates sleeping period information of the first AP, and the first information element indicates that a second AP is allowed to communicate with a station device during a sleeping period of the first AP; and determining sleeping period information of the second AP based on the sleeping period information of the first AP, where a sleeping period of the second AP is not overlapped with the sleeping period of the first AP.

In some embodiments, the first frame is sent by the first AP on a first link. The first AP broadcasts its quiet element on the first link. The sleeping period of the first AP on the first link is the same as a quiet period in quiet element information of the first AP to ensure subsequent compatibility.

The embodiments of the present disclosure provide a communication method. In an example, the method may be applied to a second AP. The method may include the following step: receiving a first frame, where the first frame includes a first information element, the first information element indicates sleeping period information of the first AP, and the first information element indicates that a second AP is allowed to communicate with a station device during a sleeping period of the first AP.

In an example, the method further includes: determining sleeping period information of the second AP based on the sleeping period information of the first AP, where a sleeping period of the second AP is not overlapped with the sleeping period of the first AP.

In an example, the first frame is sent by the first AP on a first link.

The first information element further indicates sleeping period information of a third AP on a second link; and the third AP is an AP belonging to a same AP MLD as the first AP; and A sleeping period of the second AP is not overlapped with a sleeping period of the third AP.

In an example, the sleeping period information of the third AP includes time offset information. The time offset information includes a time offset value between a start time of the sleeping period of the third AP on the second link and a start time of the sleeping period of the first AP on the first link.

In an example, the sleeping period of the third AP on the second link is the same as a quiet period in quiet element information of the third AP.

In an example, a sleeping period of the second AP is the same as a quiet period in quiet element information of the second AP.

In an example, the sleeping period of the first AP on the first link is the same as a quiet period in quiet element information of the first AP.

In an example, the first frame includes the quiet element information of the first AP.

In an example, the first frame includes a beacon frame.

In the embodiments of the present disclosure, the second AP receives the first frame, and obtains the first information element in the first frame, where the first information element indicates the sleeping period information of the first AP, and the first information element indicates that a second AP is allowed to communicate with a station device during the sleeping period of the first AP. The sleeping (or power saving state) time of the first AP is shared through the first information element, and the second AP is indicated through the first information element to be capable of communicating with a station device during the sleeping period of the first AP, where the second AP is an AP in a same OBSS as the first AP, and there may be one or more second APs. In this way, the OBSS interference between the second AP and the first AP can be avoided, the communication time between the second AP and the station device can be increased, and the service transmission efficiency can be enhanced.

Referring to FIG. 5, the embodiments of the present disclosure provide a communication method. In an example, the method may be applied to an STA. The method may include the following step 501.

At step 501, a first frame is received, where the first frame includes a first information element, the first information element indicates sleeping period information of a first AP, and the first information element indicates that the STA is allowed to communicate with a second AP during a sleeping period of the first AP.

In an example, the first AP may be an AP that does not establish an initial association with the STA. The first AP and the second AP may be APs in a same OBSS. Specifically, in a WLAN, a BSS may include an AP and one or more stations communicating with the AP. When the coverage ranges of two or more BSSs are overlapped with each other, an OBSS is formed. With the rapid increase in wireless devices and applications, an increasing number of WLANs are deployed in a dense environment composed of a plurality of OBSSs, and there are often wireless communication devices with different protocol standards in the limited environment. High-density WLAN deployment inevitably leads to overlapping regions between adjacent BSSs. To avoid interference, APs in adjacent BSSs must operate in different frequency bands. However, due to limited available frequency band resources, this requirement is often not met. When a plurality of unrelated BSSs operating in the same frequency band or with partially overlapping frequency bands are close enough to receive each other's transmission information, the AP or the STA in the BSS that is transmitting information will block the AP or the STA in other BSSs from transmitting information, which forms the problem of co-channel interference in OBSS networks, severely impacting network performance and potentially causing network paralysis.

In the embodiments of the present disclosure, the STA receives the first frame, and obtains the first information element in the first frame, where the first information element indicates the sleeping (or power saving) period information of the first AP, and the sleeping period information of the first AP may identify the first AP's sleeping start time, sleeping end time, periodic sleeping period information, or time information in the power saving state, etc. The first information element indicates that a second AP is allowed to communicate with the STA during the sleeping period of the first AP. The sleeping (or power saving state) time of the first AP is shared through the first information element, and the second AP is indicated through the first information element to be capable of communicating with the STA during the sleeping period of the first AP, where the second AP is an AP in a same OBSS as the first AP, and there may be one or more second APs. In this way, the OBSS interference between the second AP and the first AP can be avoided, the communication time between the second AP and the station device can be increased, and the service transmission efficiency can be enhanced.

In an example, the first frame includes a beacon frame; or the first frame includes a new frame, such as an AP PS announcement frame for broadcasting the sleeping period information of the first AP.

It can be understood that in the embodiments of the present disclosure, the AP and the STA may be devices supporting multi-link. For example, the AP and the STA may be represented as AP MLD and non-AP MLD, respectively. The AP MLD may represent an access point supporting a multi-link communication function. The non-AP MLD may represent a station supporting a multi-link communication function. For ease of explanation, subsequent descriptions use the AP and the STA as examples; however, this does not constitute a limitation on the embodiments of the present disclosure.

As a first example, referring to FIG. 2, which shows one application scenario of a communication method provided in an embodiment of the present disclosure. The AP1 and the STA1 form the BSS1. The AP2 and the STA2 form the BSS2. The BSS1 and the BSS2 are overlapped with each other to form an OBSS. The STA2 establishes an initial association with the AP2, but does not establish an initial association with the AP1. Taking the AP1 as the first AP as an example, the AP1 determines a first frame, carries the sleeping period information of the AP1 in the first frame, and broadcasts the first frame. Consequently, the STA2 receives the first frame and can communicate with the AP2 in the OBSS during the sleeping period of the AP1, and OBSS interference between the AP2 and the AP1 can be avoided.

The embodiments of the present disclosure provide a communication method. In an example, the method may be applied to an STA. The method may include the following step: receiving a first frame, where the first frame includes a first information element, the first information element indicates sleeping period information of a first AP, and the first information element indicates that a second AP is allowed to communicate with the STA during a sleeping period of the first AP; and the second AP is an AP in a same OBSS as the first AP.

The first frame is sent by the first AP on a first link.

The first information element further indicates sleeping period information of a third AP on a second link. The third AP is an AP belonging to a same AP MLD as the first AP. If the first AP is affiliated with a certain AP MLD and another AP (e.g., the third AP) on another link has also negotiated its sleeping period, the first AP may also broadcast, on the first link, the sleeping period of the AP on the another link. For example, the third AP operates on the second link, then the first AP may broadcast, on the first link, the sleeping period information of the third AP, indicating that other APs are capable of communicating with the STA during the sleeping period of the third AP.

The embodiments of the present disclosure provide a communication method. In an example, the method may be applied to an STA. The method may include the following step: receiving a first frame, where the first frame includes a first information element, the first information element indicates sleeping period information of a first AP, and the first information element indicates that a second AP is allowed to communicate with the STA during a sleeping period of the first AP; and the second AP is an AP in a same OBSS as the first AP.

The first frame is sent by the first AP on a first link.

The first information element further indicates sleeping period information of a third AP on a second link.

The third AP is an AP belonging to a same AP MLD as the first AP.

The sleeping period information of the third AP includes time offset information.

The sleeping period information of the third AP includes time offset information used for calculating a specific time point of the sleeping period information of the third AP. The time offset information includes a time offset value between a start time of the sleeping period of the third AP on the second link and a start time of the sleeping period of the first AP on the first link. That is, the time offset information is the time difference between the start times of the sleeping period information of the two APs. In this way, the specific time point of the sleeping period information of the third AP can be calculated by using the start time of the sleeping period of the broadcast link (i.e., the first link) and the time offset value.

The embodiments of the present disclosure provide a communication method. In an example, the method may be applied to an STA. The method may include the following step: receiving a first frame, where the first frame includes a first information element, the first information element indicates sleeping period information of a first AP, and the first information element indicates that a second AP is allowed to communicate with the STA during a sleeping period of the first AP; and the second AP is an AP in a same OBSS as the first AP.

The first frame is sent by the first AP on a first link.

The first information element further indicates sleeping period information of a third AP on a second link.

The third AP is an AP belonging to a same AP MLD as the first AP.

The sleeping period of the third AP on the second link is the same as a quiet period in quiet element information of the third AP. To ensure subsequent compatibility, the time of the sleeping period of the third AP needs to be consistent with the time set in the quiet element of the third AP. A legacy STA cannot communicate with the third AP during the quiet time set in the quiet element, and consequently cannot send any frame to communicate with the third AP during the time duration in the sleeping period.

The embodiments of the present disclosure provide a communication method. In an example, the method may be applied to an STA. The method may include the following step: receiving a first frame, where the first frame includes a first information element, the first information element indicates sleeping period information of a first AP, and the first information element indicates that a second AP is allowed to communicate with the STA during a sleeping period of the first AP; and the second AP is an AP in a same OBSS as the first AP.

The sleeping period of the first AP on the first link is the same as a quiet period in quiet element information of the first AP. The first AP broadcasts its quiet element on the first link. To ensure subsequent compatibility, the time of the sleeping period of the first AP needs to be consistent with the time set in the quiet element of the first AP. A legacy STA cannot communicate with the first AP during the quiet time set in the quiet element, and consequently cannot send any frame to communicate with the first AP during the time duration in the sleeping period.

The embodiments of the present disclosure provide a communication method. In an example, the method may be applied to an STA. The method may include the following step: receiving a first frame, where the first frame includes a first information element, the first information element indicates sleeping period information of a first AP, and the first information element indicates that a second AP is allowed to communicate with the STA during a sleeping period of the first AP; and the second AP is an AP in a same OBSS as the first AP.

The sleeping period of the first AP on the first link is the same as a quiet period in quiet element information of the first AP. The first frame includes quiet element information of the first AP.

The embodiments of the present disclosure provide a communication method. In an example, the method may be applied to an STA. The method may include the following steps: receiving a first frame, where the first frame includes a first information element, the first information element indicates sleeping period information of a first AP, and the first information element indicates that a second AP is allowed to communicate with the STA during a sleeping period of the first AP; and the second AP is an AP in a same OBSS as the first AP; and sending the sleeping period information of the first AP and identification information of the first AP to an AP associated with the STA, where the identification information of the first AP includes a BSSID of the first AP or media access control (MAC) address information of an AP MLD to which the first AP belongs.

The STA that is in the OBSS and does not establish an initial association with the broadcast AP (the first AP) may report the sleeping period information of the broadcast AP that is detected by the STA to the AP/AP MLD associated with the STA, where the BSSID of the first AP or the MAC address of the AP MLD to which the first AP belongs is included, which is in one-to-one correspondence with the sleeping period information.

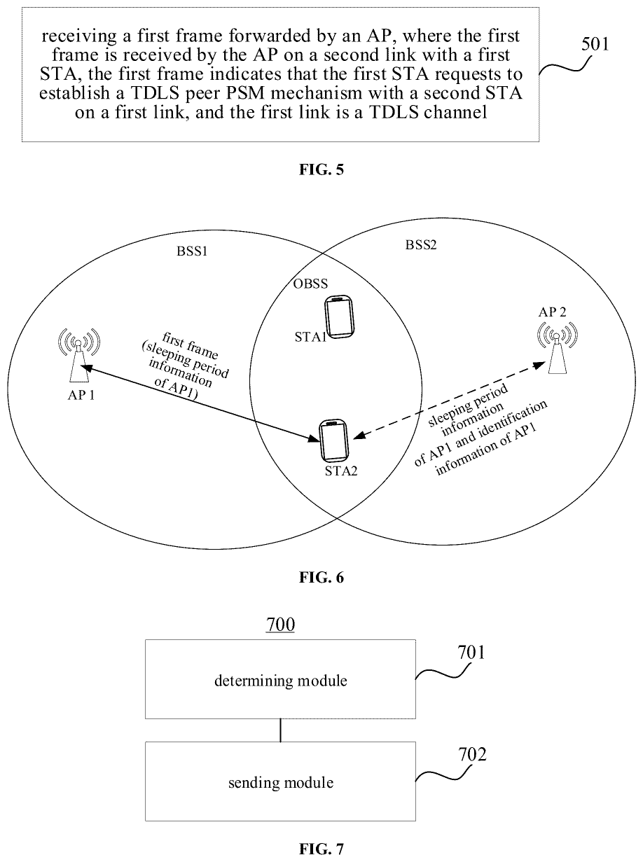

As a third example, referring to FIG. 6, which shows a third application scenario of a communication method provided in an embodiment of the present disclosure. The AP1 and the STA1 form the BSS1. The AP2 and the STA2 form the BSS2. The BSS1 and the BSS2 are overlapped with each other to form an OBSS. The STA2 establishes an initial association with the AP2, but does not establish an initial association with the AP1. Taking the AP1 as the first AP as an example, the API carries the sleeping period information of the AP1 in the first frame, and broadcasts the first frame.

Consequently, based on the received sleeping period of the AP1, STA2 sends the sleeping period information of the AP1 and the identification information of the AP1 to the AP associated with the STA2, such as the AP2.

The embodiments of the present disclosure provide a communication method. In an example, the method may be applied to an STA. The method may include the following step: receiving a first frame, where the first frame includes a first information element, the first information element indicates sleeping period information of a first AP, and the first information element indicates that a second AP is allowed to communicate with the STA during a sleeping period of the first AP.

The first information element further indicates sleeping period information of a third AP on a second link.

The third AP is an AP belonging to a same AP MLD as the first AP.

The sleeping period information of the third AP and the identification information of the third AP are sent to the AP associated with the STA. The identification information of the third AP includes the BSSID of the third AP or the MAC address information of the AP MLD to which the third AP belongs. The STA that is in the OBSS and does not establish an initial association with the third AP may report the sleeping period information of the third AP that is detected by the STA to the AP/AP MLD associated with the STA, where the BSSID of the third AP or the MAC address of the AP MLD to which the third AP belongs is included, which is in one-to-one correspondence with the sleeping period information.

The embodiments of the present disclosure provide a communication method. In an example, the method may be applied to an STA. The method may include the following step: receiving a first frame, where the first frame includes a first information element, the first information element indicates sleeping period information of a first AP, and the first information element indicates that the STA is allowed to communicate with a second AP during a sleeping period of the first AP.

In an example, the first frame is sent by the first AP on a first link.

The first information element further indicates sleeping period information of a third AP on a second link.

The third AP is an AP belonging to a same AP MLD as the first AP.

In an example, the sleeping period information of the third AP includes time offset information.

The time offset information includes a time offset value between a start time of a sleeping period of the third AP on the second link and a start time of the sleeping period of the first AP on the first link.

In an example, a sleeping period of the third AP on the second link is the same as a quiet period in quiet element information of the third AP.

In an example, the sleeping period of the first AP on a first link is the same as a quiet period in quiet element information of the first AP.

In an example, the first frame includes the quiet element information of the first AP.

In an example, the first frame includes a beacon frame.

In an example, the method further includes: sending the sleeping period information of the first AP and identification information of the first AP to an AP associated with the STA, where the identification information of the first AP includes a BSSID of the first AP or MAC address information of an AP MLD to which the first AP belongs.

In an example, the method further includes: sending the sleeping period information of the third AP and identification information of the third AP to an AP associated with the STA, where the identification information of the third AP includes a BSSID of the third AP or MAC address information of an AP MLD to which the third AP belongs.

In the embodiments of the present disclosure, the STA receives the first frame, and obtains the first information element in the first frame, where the first information element indicates the sleeping period information of the first AP, and the first information element indicates that a second AP is allowed to communicate with the STA during the sleeping period of the first AP. The sleeping (or power saving state) time of the first AP is shared through the first information element, and the second AP is indicated through the first information element to be capable of communicating with the STA during the sleeping period of the first AP, where the second AP is an AP in a same OBSS as the first AP, and there may be one or more second APs. In this way, the OBSS interference between the second AP and the first AP can be avoided, the communication time between the second AP and the station device can be increased, and the service transmission efficiency can be enhanced.

Referring to FIG. 7, based on the same principle as the method provided in the embodiments of the present disclosure, the embodiments of the present disclosure further provide an electronic device 700. The electronic device 700 is a first AP. The electronic device includes: a determining module 701, configured to determine a first frame, where the first frame includes a first information element, the first information element indicates sleeping period information of the first AP, and the first information element indicates that a second AP is allowed to communicate with a station device during a sleeping period of the first AP; and a sending module 702, configured to send the first frame.

The electronic device 700 further performs other steps executed by the first AP in the preceding embodiments, which are not repeated herein.

The embodiments of the present disclosure further provide a communication apparatus applied to a first AP. The apparatus includes: a frame determining module, configured to determine a first frame, where the first frame includes a first information element, the first information element indicates sleeping period information of the first AP, and the first information element indicates that a second AP is allowed to communicate with a station device during a sleeping period of the first AP; and a frame sending module, configured to send the first frame.

The apparatus further includes other modules of the electronic device described in the preceding embodiments, which are not repeated herein.

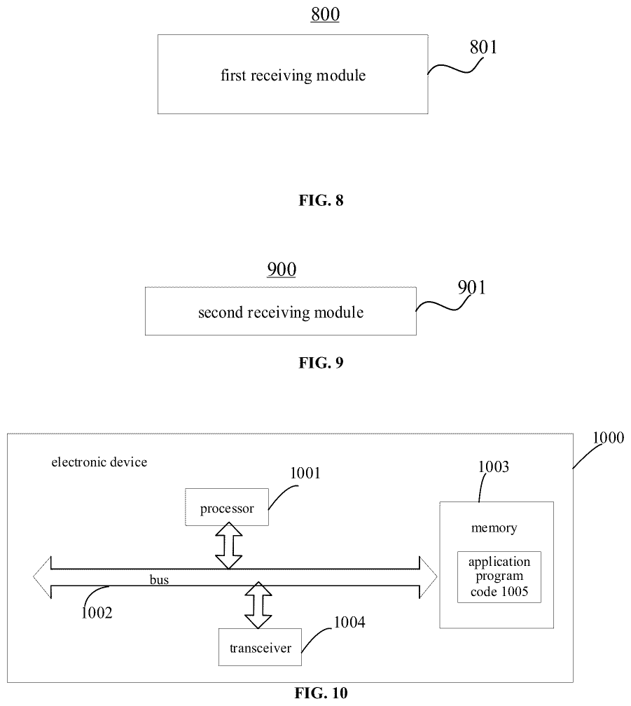

Referring to FIG. 8, based on the same principle as the method provided in the embodiments of the present disclosure, the embodiments of the present disclosure further provide an electronic device 800. The electronic device 800 is a second AP. The electronic device includes: a first receiving module 801, configured to receive a first frame, where the first frame includes a first information element, the first information element indicates sleeping period information of the first AP, and the first information element indicates that a second AP is allowed to communicate with a station device during a sleeping period of the first AP.

The electronic device 800 further performs other steps executed by the second AP in the preceding embodiments, which are not repeated herein.

The embodiments of the present disclosure further provide a communication apparatus applied to a second AP. The apparatus includes: a frame first receiving module, configured to receive a first frame, where the first frame includes a first information element, the first information element indicates sleeping period information of the first AP, and the first information element indicates that a second AP is allowed to communicate with a station device during a sleeping period of the first AP.

The apparatus further includes other modules of the electronic device described in the preceding embodiments, which are not repeated herein.

Referring to FIG. 9, based on the same principle as the method provided in the embodiments of the present disclosure, the embodiments of the present disclosure further provide an electronic device 900. The electronic device is an STA. The electronic device 900 includes: a second receiving module 901, configured to receive a first frame, where the first frame includes a first information element, the first information element indicates sleeping period information of a first AP, and the first information element indicates that a second AP is allowed to communicate with the STA during a sleeping period of the first AP; the second AP is an AP belonging to a same OBSS as the first AP.

The electronic device 900 further performs other steps executed by the STA in the preceding embodiments, which are not repeated herein.

The embodiments of the present disclosure further provide a communication apparatus applied to an STA. The apparatus includes: a second receiving module, configured to receive a first frame, where the first frame includes a first information element, the first information element indicates sleeping period information of a first AP, and the first information element indicates that a second AP is allowed to communicate with the STA during a sleeping period of the first AP; the second AP is an AP belonging to a same OBSS as the first AP.

The apparatus further includes other modules of the electronic device described in the preceding embodiments, which are not repeated herein.

In an embodiment, the embodiments of the present disclosure also provide an electronic device, as shown in FIG. 10. The electronic device 1000 shown in FIG. 10 may be a server, including a processor 1001 and a memory 1003. The processor 1001 and the memory 1003 are connected to each other, such as through a bus 1002. In an example, the electronic device 1000 may also include a transceiver 1004. It should be noted that in actual applications, the transceiver 1004 is not limited to one, and the structure of the electronic device 1000 does not constitute a limitation on the embodiments of the present disclosure.

The processor 1001 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. It can implement or execute various exemplary logic blocks, modules, and circuits described in conjunction with the content of the present disclosure. The processor 1001 may also be a combination that implements computing functions, such as a combination including one or more microprocessors, a combination of a DSP and a microprocessor, etc.

The bus 1002 may include a path to transmit information between the above components. The bus 1002 may be a peripheral component interconnect (PCI) bus or an extended industry standard architecture (EISA) bus, etc. The bus 1002 may be divided into an address bus, a data bus, a control bus, etc. For ease of representation, only one thick line is used in FIG. 10, but it does not mean that there is only one bus or one type of bus.

The memory 1003 may be a read only memory (ROM) or other types of static storage devices that can store static information and instructions, a random access memory (RAM) or other types of dynamic storage devices that can store information and instructions, or an electrically erasable programmable read only memory (EEPROM), a compact disc read only memory (CD-ROM), or other optical disk storage, optical disk storage (including compressed optical disk, laser disk, optical disk, digital versatile disk, Blu-ray disk, etc.), a disk storage medium, or other magnetic storage devices, or any other medium that can be used for carrying or storing the desired program code in the form of instructions or data structures and can be accessed by a computer, but is not limited thereto.

The memory 1003 is used for storing the application program code 1005 for executing the solutions of the present disclosure, and is controlled by the processor 1001 to execute. The processor 1001 is used for executing the application program code stored in the memory 1003 to implement the content shown in the aforementioned method embodiments.

The electronic device includes, but is not limited to, a mobile terminal, such as a mobile phone, a laptop, a digital broadcast receiver, a personal digital assistant (PDA), a tablet computer (PAD), a portable multimedia player (PMP), a vehicle-mounted terminal (such as a vehicle-mounted navigation terminal), etc., and a fixed terminal such as a digital TV, a desktop computer, etc. The electronic device shown in FIG. 10 is only an example and should not impose any restrictions on the functions and scope of use of the embodiments of the present disclosure.

The server provided in the present disclosure may be a standalone physical server, or a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smartphone, a tablet computer, a laptop computer, a desktop computer, a smart speaker, a smart watch, etc., but is not limited thereto. The terminal and the server may be directly or indirectly connected to each other via a wired or wireless communication manner, which is not limited in the present disclosure.

The embodiments of the present disclosure provide a computer-readable storage medium. The computer-readable storage medium stores a computer program. When the computer program is run on a computer, the computer is caused to execute the corresponding contents in the aforementioned method embodiments.

It should be understood that, although the steps in the flowchart of the accompanying drawings are displayed in sequence as indicated by the arrows, these steps are not necessarily executed in the order indicated by the arrows. Unless otherwise specified in this article, the execution of these steps is not strictly limited in order, and they can be executed in other orders. Moreover, at least part of the steps in the flowchart of the accompanying drawings may include multiple sub-steps or multiple stages, and these sub-steps or stages are not necessarily executed at the same time, but can be executed at different times, and their execution order is not necessarily sequential, but can be executed in turn or alternately with other steps or at least part of the sub-steps or stages of other steps.

It should be noted that the computer-readable medium described above in the present disclosure may be a computer-readable signal medium, a computer-readable storage medium, or any combination of the above two. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to, an electrical connection with one or more wires, a portable computer disk, a hard disk, an RAM, an ROM, an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that can be used by or in conjunction with an instruction execution system, apparatus, or device. In the present disclosure, the computer-readable signal medium may include a data signal propagated in a baseband or as part of a carrier wave, in which a computer-readable program code is carried. Such propagated data signals may take a variety of forms including, but not limited to, electromagnetic signals, optical signals, or any suitable combination of the above. The computer-readable signal medium may also be any computer-readable medium other than a computer-readable storage medium. The computer-readable signal medium may send, propagate, or transmit a program for use by or in conjunction with an instruction execution system, apparatus, or device. The program code contained in the computer-readable medium may be transmitted by any appropriate medium including, but not limited to, wires, optical cables, radio frequency (RF), etc., or any suitable combination of the above.

The computer-readable medium described above may be contained in the electronic device described above, or the computer-readable medium may exist separately without being assembled into the electronic device.

The computer-readable medium described above carries one or more programs, and when the one or more programs described above are executed by the electronic device, the electronic device is caused to execute the methods shown in the embodiments described above.

According to an aspect of the present disclosure, a computer program product or a computer program is provided. The computer program product or the computer program includes computer instructions, and the computer instructions are stored in a computer-readable storage medium. The processor of the computer device reads the computer instructions from the computer-readable storage medium, and the processor executes the computer instructions, causing the computer device to execute the methods provided in the various implementations described above.

The computer program code for performing the operation of the present disclosure may be written in one or more programming design languages or a combination thereof, and the programming design languages described above include object-oriented programming design languages—such as Java, Smalltalk, C++, and also include conventional procedural programming design languages-such as “C” language or similar programming design languages. The program code may be executed entirely on the user's computer, partially on the user's computer, as a stand-alone software package, partially on the user's computer and partially on a remote computer, or entirely on a remote computer or a server. In cases involving the remote computer, the remote computer may be connected to the user's computer through any type of network, including a local area network (LAN) or a wide area network (WAN), or may be connected to an external computer (e.g., connected through the Internet by using an Internet service provider).

The flowcharts and block diagrams in the accompanying drawings illustrate the possible implementation architectures, functions, and operations of the systems, methods, and computer program products according to various embodiments of the present disclosure. In this regard, each block in the flowchart or block diagram may represent a module, a program segment, or a portion of a code, which contains one or more executable instructions for implementing a specified logical function. It should also be noted that, in some alternative implementations, the functions marked in the block may also occur in an order different from that marked in the accompanying drawings. For example, two blocks represented in succession may actually be executed substantially in parallel, and they may sometimes be executed in a reverse order, depending on the functions involved. It should also be noted that each block in the block diagram and/or flowchart, and the combination of blocks in the block diagram and/or flowchart, can be implemented by a dedicated hardware-based system that performs the specified function or operation, or can be implemented by a combination of dedicated hardware and computer instructions.

The modules involved in the embodiments described in the present disclosure can be implemented by software or by hardware. The name of the module does not constitute a limitation on the module itself in some cases. For example, module A may also be described as “module A for performing operation B”.

The above description is only a preferred embodiment of the present disclosure and an explanation of the adopted technical principles. Those skilled in the art should understand that, the disclosed scope involved in the present disclosure is not limited to the technical solutions formed by a specific combination of the above technical features, but also should cover other technical solutions formed by any combination of the above technical features or their equivalent features without departing from the above concept of the disclosure, for example, technical solutions formed by interchanging the above features with technical features with similar functions disclosed in the present disclosure (but not limited to).

1. A communication method, performed by a first access point (AP), comprising:
determining a first frame, wherein the first frame comprises a first information, the first information indicates sleeping period information of the first AP, and the first information indicates that a second AP is allowed to communicate with a station device during a sleeping period of the first AP; and
sending the first frame.

2. The communication method according to claim 1, wherein
the first frame is sent by the first AP on a first link;
the first information further indicates sleeping period information of a third AP on a second link; and
the third AP is an AP belonging to a same AP multi-link device (MLD) as the first AP.

3. The communication method according to claim 2, wherein
the sleeping period information of the third AP comprises time offset information; and
the time offset information comprises a time offset value between a start time of a sleeping period of the third AP on the second link and a start time of the sleeping period of the first AP on the first link.

4. The communication method according to claim 2, wherein a sleeping period of the third AP on the second link is the same as a quiet period in quiet element information of the third AP.

5. The communication method according to claim 2, wherein the sleeping period of the first AP on the first link is the same as a quiet period in quiet element information of the first AP.

6. The communication method according to claim 5, wherein the first frame comprises the quiet element information of the first AP.

7. The communication method according to claim 1, wherein the first frame comprises a beacon frame.

8. A communication method, performed by a second access point (AP), comprising:
receiving a first frame, wherein the first frame comprises a first information, the first information indicates sleeping period information of the first AP, and the first information indicates that a second AP is allowed to communicate with a station device during a sleeping period of the first AP.

9. The communication method according to claim 8, further comprising:
determining sleeping period information of the second AP based on the sleeping period information of the first AP, wherein a sleeping period of the second AP is not overlapped with the sleeping period of the first AP.

10. The communication method according to claim 9, wherein
the first frame is sent by the first AP on a first link;
the first information further indicates sleeping period information of a third AP on a second link; and the third AP is an AP belonging to a same AP multi-link device (MLD) as the first AP; and
a sleeping period of the second AP is not overlapped with a sleeping period of the third AP.

11. The communication method according to claim 10, wherein
the sleeping period information of the third AP comprises time offset information; and
the time offset information comprises a time offset value between a start time of the sleeping period of the third AP on the second link and a start time of the sleeping period of the first AP on the first link.

12. (canceled)

13. The communication method according to claim 8, wherein a sleeping period of the second AP is the same as a quiet period in quiet element information of the second AP.

14. The communication method according to claim 10, wherein the sleeping period of the first AP on the first link is the same as a quiet period in quiet element information of the first AP.

15-16. (canceled)

17. A communication method, performed by a station (STA), comprising:
receiving a first frame, wherein the first frame comprises a first information, the first information indicates sleeping period information of a first access point (AP), and the first information indicates that the STA is allowed to communicate with a second AP during a sleeping period of the first AP.

18. The communication method according to claim 17, wherein the first frame is sent by the first AP on a first link;
the first information further indicates sleeping period information of a third AP on a second link; and
the third AP is an AP belonging to a same AP multi-link device (MLD) as the first AP.

19. The communication method according to claim 18, wherein the sleeping period information of the third AP comprises time offset information; and
the time offset information comprises a time offset value between a start time of a sleeping period of the third AP on the second link and a start time of the sleeping period of the first AP on the first link.

20. (canceled)

21. The communication method according to claim 17, wherein the sleeping period of the first AP on a first link is the same as a quiet period in quiet element information of the first AP.

22-23. (canceled)

24. The communication method according to claim 17, further comprising:
sending the sleeping period information of the first AP and identification information of the first AP to an AP associated with the STA, wherein the identification information of the first AP comprises a basic service set identifier (BSSID) of the first AP or media access control (MAC) address information of an AP MLD to which the first AP belongs; or
the first frame is sent by the first AP on a first link, the first information further indicates sleeping period information of a third AP on a second link, and the third AP is an AP belonging to a same AP multi-link device (MLD) as the first AP; and the method further comprises: sending the sleeping period information of the third AP and identification information of the third AP to an AP associated with the STA, wherein the identification information of the third AP comprises a BSSID of the third AP or MAC address information of an AP MLD to which the third AP belongs.

25-28. (canceled)

29. An electronic device, comprising:
a processor; and
a memory, storing a computer program executable on the processor,
wherein the processor, through executing the computer program, is configured to perform the method according to claim 1.

30. A non-transitory computer-readable storage medium, storing a computer program that, when executed by a processor, causes the processor to perform the method according to claim 1.
